(19) United States
(12) Patent Application Publication
(10) Pub. No.: US 2025/0089808 A1
(43) Pub. Date: Mar. 20, 2025

(54) AEROSOL GENERATING DEVICE AND METHOD OF CONTROLLING POWER SUPPLY

(71) Applicant: KT&G CORPORATION, Daejeon (KR)

(72) Inventors: Yong Hwan KIM, Gyeonggi-do (KR); Young Bum KWON, Gyeonggi-do (KR); Dong Sung KIM, Seoul (KR); Jun Yeop OH, Gyeonggi-do (KR); Hun lI LIM, Seoul (KR); Seok Su JANG, Daejeon (KR)

(73) Assignee: KT&G CORPORATION, Daejeon (KR)

(21) Appl. No.: 18/566,316

(22) PCT Filed: Sep. 5, 2023
(86) PCT No.: PCT/KR2023/013263

§ 371 Date: Dec. 1, 2023

(30) Foreign Application Priority Data
Sep. 5, 2022 (KR) 10-2022-0112370
Jan. 17, 2023 (KR) 10-2023-0006925

(51) Int. Cl. A24F 40/57; A24F 40/20; A24F 40/51; A24F 40/53; A24F 40/65

(52) U.S. Cl. CPC A24F 40/57; A24F 40/20; A24F 40/51; A24F 40/53; A24F 40/65

(57) ABSTRACT

An aerosol generating device includes a housing including an accommodation space for accommodating at least a portion of an aerosol generating article, a heater configured to heat the aerosol generating article inserted into the accommodation space, a temperature sensor configured to measure a temperature of the heater, a battery configured to supply power to the heater, and a processor electrically connected to the heater and the battery, wherein the processor is configured to obtain at least one of data associated with an initial temperature of the heater, which is measured through the temperature sensor, and data associated with a final heating profile of the heater, and control power supply from the battery to the heater, based on the obtained data. Various embodiments may be made.

### TECHNICAL FIELD

One or more embodiments relate to an aerosol generating device and a method of operating the same, and more particularly, to an aerosol generating device for controlling power supply to a heater based on a temperature of the heater and a state of a cigarette.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes.

When an aerosol generating article is inserted into an accommodation space, the aerosol generating device may heat an aerosol generating article according to a preset temperature profile. The temperature profile may refer to temperature change data of a heater or an aerosol generating article during smoking. Aerosols generated according to the heating of the aerosol generating article may differ according to components of an aerosol generating material included in the aerosol generating article. For example, according to the amount of moisture contained in the aerosol generating material, the temperature, amount, etc. of the generated aerosols may vary.

### DISCLOSURE OF INVENTION

### Technical Problem

When an aerosol generating article contains a certain amount of moisture, aerosols of an appropriate temperature and amount may be generated as the aerosol generating article is preheated. However, when the amount of moisture in the aerosol generating article is greater than an appropriate range when preheated, the temperature increase speed of a heater decreases due to the moisture such that an excessive amount of vapor may be generated, and aerosols with high temperature may be generated.

In particular, when a plurality of aerosol generating articles are included in one package and the amount of moisture in any one of the aerosol generating articles is greater than an appropriate range, it may be assumed that all of the aerosol generating articles included in the package are exposed to a highly humid environment.

According to one or more embodiments, provided is an aerosol generating device, in which heating profiles are differently set by assuming, based on a state of an aerosol generating article used in previous smoking, the amount of moisture in an aerosol generating article used during continued smoking.

The technical problems of the disclosure are not limited to the aforementioned description and technical problems that are not stated may be clearly understood by one of ordinary skill in the art from the embodiments described hereinafter and the attached drawings.

### Solution to Problem

An aerosol generating device includes a housing including an accommodation space for accommodating at least a portion of an aerosol generating article, a heater configured to heat the aerosol generating article inserted into the accommodation space, a temperature sensor configured to measure a temperature of the heater, a battery configured to supply power to the heater, and a processor electrically connected to the heater and the battery, wherein the processor is configured to obtain at least one of data associated with an initial temperature of the heater, which is measured through the temperature sensor, and data associated with a final heating profile of the heater, and control power supply from the battery to the heater, based on the obtained data.

An operating method of an aerosol generating device includes obtaining at least one of data associated with an initial temperature of the heater configured to heat an aerosol generating article inserted into an accommodation space and data associated with a final heating profile of the heater, the initial temperature being measured through a temperature sensor, and controlling power supply from a battery to the heater, based on the obtained data.

### Advantageous Effects of Invention

According to one or more embodiments, by setting heating temperature profiles based on continued smoking determined based on an initial temperature of a heater and the state of a cigarette used during previous smoking, the user's risk of burns caused by an excessively humid cigarette may be minimized.

Also, according to one or more embodiments, by setting heating profiles assuming that the cigarette is in an over-humidified state when preset conditions are satisfied, the efficiency may be improved by omitting the detection operation when there is a relatively low need to detect the state of the cigarette.

Effects of the embodiments are not limited to those stated above, and effects that are not described herein may be clearly understood by one of ordinary skill in the art from the present specification and the attached drawings.

### BRIEF DESCRIPTION OF DRAWINGS

FIG. 1 illustrates an aerosol generating system according to an embodiment.

FIG. 2 illustrates an aerosol generating article according to an embodiment.

FIG. 3 is a flowchart illustrating an aerosol generating device in which the power supply to a heater is controlled, according to an embodiment.

FIG. 4 is a detailed flowchart illustrating the aerosol generating device of FIG. 3 in which the power supply to a heater is controlled.

FIG. 5 illustrates a temperature profile including a preheating profile regarding an aerosol generating article in a normal state, according to an embodiment.

FIG. 6 illustrates a temperature profile including a preheating profile regarding an aerosol generating article in an over-humidified state, according to an embodiment.

FIG. 7A illustrates that an aerosol generating article is continuously inserted after an excessively humid aerosol generating article is inserted into an aerosol generating device, according to an embodiment.

FIG. 7B illustrates an example of data stored in a memory of the aerosol generating device of FIG. 7A.

FIG. 8A illustrates a state in which an aerosol generating article is inserted after a certain period of time has passed after an excessively humid aerosol generating article is inserted into an aerosol generating device, according to an embodiment.

FIG. 8B illustrates an example of data stored in a memory of the aerosol generating device of FIG. 8A.

FIG. 9A illustrates that an aerosol generating article is continuously inserted after an aerosol generating article in a normal state is inserted into an aerosol generating device, according to an embodiment,

FIG. 9B illustrates an example of data stored in a memory of the aerosol generating device of FIG. 9A.

FIG. 10 illustrates an example of a first temperature profile and a second temperature profile, according to an embodiment.

FIG. 11 illustrates an example of a final heating profile and a second temperature profile of a heater, according to an embodiment.

FIG. 12 is a block diagram of an aerosol generating device according to another embodiment.

### BEST MODE FOR CARRYING OUT THE INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, hen an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track,

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An acrosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. That is, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the suspector may be a magnetic body that generates heat by an external magnetic field. As the suspector is positioned inside the coil and a magnetic field is applied to the suspector, the suspector generates heat to heat an aerosol generating article. In addition, optionally, the suspector may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

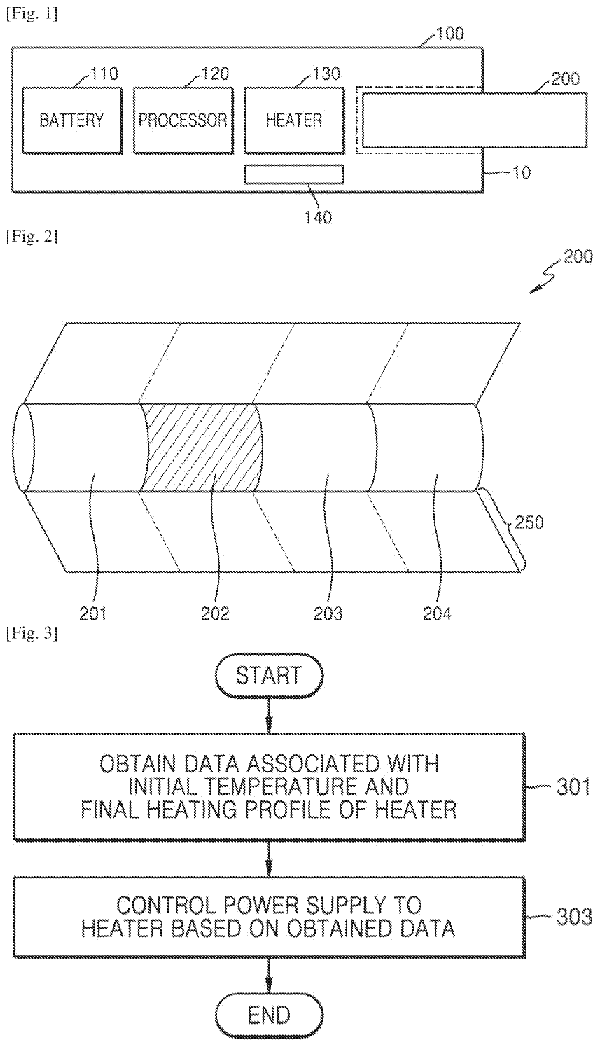

FIG. 1 illustrates an aerosol generating system according to an embodiment.

Referring to FIG. 1, the aerosol generating system may include an aerosol generating device 10 and an acrosol generating article 200. The aerosol generating device 10 may include a housing 100 including an accommodation space into which at least a portion of the aerosol generating article 200 is inserted and may generate aerosols by heating the aerosol generating article 200 inserted into the accommodation space. The aerosol generating article 200 may be of a cigarette-type and include an aerosol generating material. For convenience of explanation, FIG. 1 illustrates that the aerosol generating device 10 is used together with the aerosol generating article 200 of a cigarette-type, but one or more embodiments are not limited thereto. Although the aerosol generating device 10 is not of a cigarette-type, the aerosol generating device 10 may be used together with the aerosol generating article of any other suitable type.

In an embodiment, the aerosol generating device 10 may include a battery 110, a processor 120, a heater 130, and a temperature sensor 140. However, the internal structure of the aerosol generating device 10 is not limited to that illustrated in FIG. 1. According to the design of the aerosol generating device 10, it will be understood by one of ordinary skill in the art that some of the hardware components illustrated in FIG. 1 may be omitted or new components may be added.

In an embodiment, the battery 110 may supply power used to operate the aerosol generating device 10. For example, when the heater 130 is an induction heater, the battery 110 may supply power to make an induction coil of the heater 130 generate a variable magnetic field. As another example, when the heater 130 is a resistive heater, the battery 110 may supply power to make currents flow through an electrically conductive track of the heater 130.

In an embodiment, the processor 120 may be hardware for controlling general operations of the aerosol generating device 10. For example, the processor 120 may control not only operations of the battery 110, the heater 130, and the temperature sensor 140, but also operations of other components included in the aerosol generating device 10. Also, the processor 120 may check the state of each of the components of the aerosol generating device 10 to determine whether or not the aerosol generating device 10 is able to operate.

In an embodiment, the processor 120 may store, in a separate memory (not shown), data associated with general operations of the processor 120. For example, the processor 120 may store, in the separate memory, points in time when the power supply from the battery 110 starts and ends, a value of power supplied from the battery 110, and data associated with a power supply operation (that is, including a heating operation) such as a heating profile of the heater 130.

In an embodiment, the heater 130 may heat the aerosol generating article 200 inserted into the accommodation space of the aerosol generating device 10. For example, when the heater 130 is an induction heater, the heater 130 may include an induction coil and a susceptor. In this case, when a variable magnetic field is generated by the induction coil, the susceptor may be heated as the generated variable magnetic field is applied to the susceptor. When the susceptor is of a tube type or a cylinder type, the susceptor may be arranged to surround the aerosol generating article 200 and heat the same. When the susceptor is of a needle type or a rod type, the susceptor may be arranged to be inserted into the aerosol generating article 200 and heat the same. However, the heating method of the heater 130 is not limited thereto, and the heater 130 may operate according to a resistive heating method.

In an embodiment, the temperature sensor 140 may measure the temperature of the heater 130. For example, the temperature sensor 140 may be arranged to be in the vicinity of the heater 130 or in contact with the heater 130 and thus may measure the temperature of the heater 130. The temperature sensor 140 may be a Resistance Temperature Detector (RTD) sensor, a Negative Temperature Coefficient of Resistance (NTC) sensor, or a Positive Temperature Coefficient of Resistance (PTC) sensor, but types of the temperature sensor 140 are not limited thereto.

In an embodiment, the processor 120 may measure an initial temperature of the heater 130 through the temperature sensor 140 as an input regarding the aerosol generating device 10 (e.g., an input of a signal regarding the insertion of the aerosol generating article 200) is received. In this case, the expression “the initial temperature of the heater” may refer to a temperature measured at a point in time when a signal regarding the insertion of the aerosol generating article 200 is input to the aerosol generating device 10 or at a point in time when a signal switching a power state of the aerosol generating device 10 from an off state to an on state is input.

In an embodiment, based on the initial temperature of the heater 130 which is measured by the temperature sensor 140, the processor 120 may determine whether an input to the aerosol generating device 10 is relevant to an input regarding continued smoking or initial smoking. In this case, the term “continued smoking” refers to a smoking action performed as a new cigarette is inserted immediately after the completion of a previous smoking action with another cigarette, and the term “initial smoking” refers to a smoking action performed as a cigarette is inserted when no previous smoking action exists (i.e., when there has been no smoking action for a certain time period).

In an embodiment, when the initial temperature of the heater 130 satisfies a certain condition, the processor 120 may obtain data associated with a final heating profile of the heater 130 from the memory. In this case, the term “final heating profile” may indicate a temperature profile applied to the heater 130 during previous smoking, based on a point in time when smoking starts. For example, the processor 120 may obtain the data associated with the final heating profile of the heater 130 when the initial temperature of the heater 130, which is measured by the temperature sensor 140, is equal to or higher than a preset temperature.

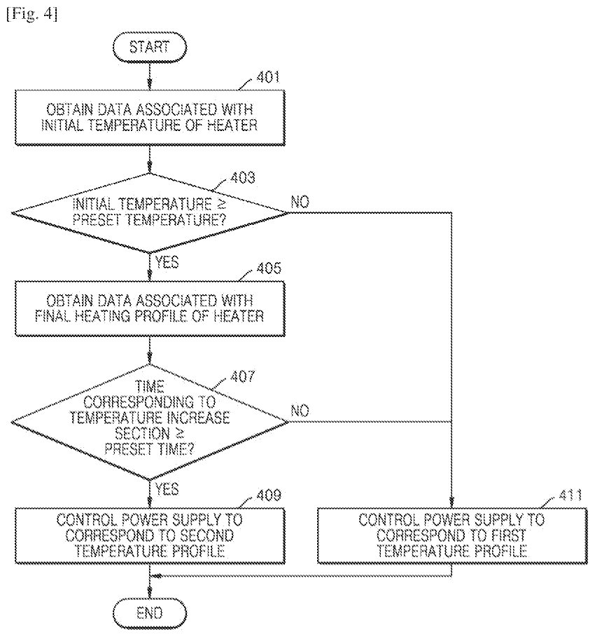

FIG. 2 illustrates an aerosol generating article according to an embodiment.

Referring to FIG. 2, the aerosol generating article 200 may be divided into a first portion 201, a second portion 202, a third portion 203, and a fourth portion 204, and the first portion 201, the second portion 202, the third portion 203, and the fourth portion 204 may include an aerosol generating element, a tobacco element, a cooling element, and a filter element, respectively. In detail, the first portion 201 may include an aerosol generating material, the second portion 202 may include a tobacco material and a moisturizer, the third portion 203 may include a medium for cooling airflow passing through the first portion 201 and the second portion 202, and the fourth portion 204 may include a filter material.

The first portion 201, the second portion 202, the third portion 203, and the fourth portion 204 may be sequentially aligned in the lengthwise direction of the aerosol generating article 200. In this case, the lengthwise direction of the aerosol generating article 200 may be a direction in which the length of the aerosol generating article 200 extends. For example, the lengthwise direction of the aerosol generating article 200 may be a direction from the first portion 201 towards the fourth portion 204. Accordingly, an aerosol generated from at least one of the first portion 201 and the second portion 202 may form airflow by sequentially passing through the first portion 201, the second portion 202, the third portion 203, and the fourth portion 204, and accordingly, a user may inhale the aerosol from the fourth portion 204.

In an embodiment, the first portion 201 may include a crimped sheet, and the aerosol generating clement may be included in the first portion 201 while impregnated in the crimped sheet. Also, while absorbed into the crimped sheet, other additives, such as flavors, a wetting agent, and/or organic acid, and a flavored liquid may be included in the first portion 201. The crimped sheet may be a sheet including a polymer material. For example, the polymer material may include at least one of paper, cellulose acetate, lyocell, and polylactic acid. For example, the crimped sheet may be a paper sheet that, even when heated to a high temperature, does not produce a heat-induced odor. However, one or more embodiments are not limited thereto.

In an embodiment, the first portion 201 may extend from an end portion of the aerosol generating article 200 to a point of about 7 mm to about 20 mm, and the second portion 202 may extend from the end of the first portion 201 to the point of about 7 mm to about 20 mm. However, one or more embodiments are not limited to the numerical ranges stated above, and the length to which each of the first portion 201 and the second portion 202 extends may be appropriately adjusted within a range that may be easily modified by one of ordinary skill in the art.

In an embodiment, the second portion 202 may include a tobacco element. The tobacco element may be a tobacco material of a certain type. For example, the tobacco element may be in the form of tobacco bits, tobacco particles, a tobacco sheet, tobacco beads, tobacco granules, a tobacco powder, or tobacco extract. Also, the tobacco material may include, for example, one or more of tobacco leaves, tobacco leaf veins, expanded tobacco, cut tobacco bits, sheet tobacco bits, and reconstituted tobacco.

In an embodiment, the third portion 203 may include a medium for cooling the airflow passing through the first portion 201 and the second portion 202. The third portion 203 may be formed of a polymer material or a biodegradable polymer material and have a cooling function. For example, the third portion 203 may be formed of polylactic acid (PLA) fibers, but one or more embodiments are not limited thereto. Alternatively, the third portion 203 may include a cellulose acetate filter including therein a plurality of holes. However, the third portion 203 is not limited thereto, and any material having an aerosol cooling function may be used. For example, the third portion 203 may be a tube filter or a paper tube including a hollow.

In an embodiment, the fourth portion 204 may include a filter material. For example, the fourth portion 204 may include a cellulose acetate filter. Shapes of the fourth portion 204 are not limited. For example, the fourth portion 204 may include a cylinder-type rod or a tube-type rod having a hollow inside. Also, the fourth portion 204 may include a recess-type rod. When the fourth portion 204 includes a plurality of segments, at least one of the plurality of segments may have a different shape.

In an embodiment, the fourth portion 204 may be formed to generate flavors. For example, a flavored liquid may be injected onto the fourth portion 204, or an additional fiber coated with the flavored liquid may be inserted into the fourth portion 204.

In an embodiment, the aerosol generating article 200 may include a wrapper 250 surrounding at least some of the first portion 201 to the fourth portion 204. Also, the aerosol generating article 200 may include the wrapper 250 surrounding all of the first portion 201 to the fourth portion 204. The wrapper 250 may be located on the outermost portion of the aerosol generating article 200, and the wrapper 250 may be a single wrapper, but may be a combination of wrappers.

In an embodiment, the wrapper 250 may include a heat conductive material. For example, the heat conductive material may be metal foil, such as silver (Ag) foil paper, aluminum (Al) foil paper, or copper (Cu) foil paper, but one or more embodiments are not limited thereto. The heat conductive material included in the wrapper 250 may uniformly distribute heat transmitted to the first portion 201 and the second portion 202, and thus, the heat conductivity may be increased, and taste of the tobacco may be improved. Also, the heat conductive material included in the wrapper 250 may function as a susceptor.

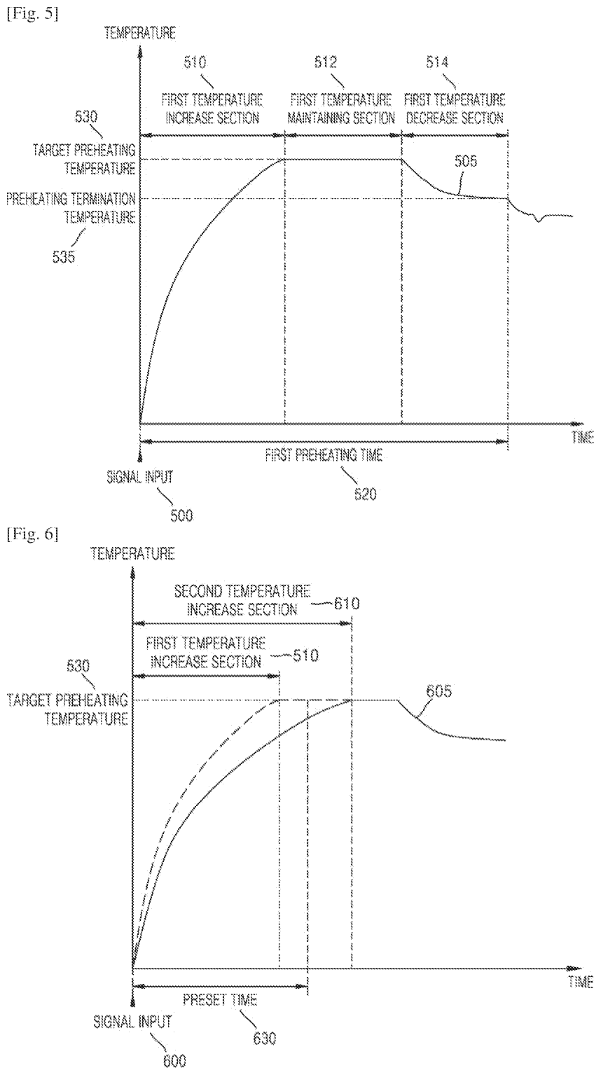

FIG. 3 is a flowchart illustrating an aerosol generating device in which the power supply to a heater is controlled, according to an embodiment.

Referring to FIG. 3, in operation 301, a processor (e.g., the processor 120 of FIG. 1) of an aerosol generating device (e.g., the aerosol generating device 10 of FIG. 1) may obtain data associated with an initial temperature of a heater (e.g., the heater 130 of FIG. 1) and a final heating profile of the heater 130. For example, the processor 120 may obtain the initial temperature of the heater 130 that is measured by a temperature sensor (e.g., the temperature sensor 140 of FIG. 1), and when the obtained initial temperature of the heater 130 satisfies a certain condition, the processor 120 may obtain the final heating profile of the heater 130 from a memory (not shown).

In an embodiment, the processor 120 may detect the initial temperature of the heater 130 through the temperature sensor 140. For example, when a signal regarding the insertion of the aerosol generating article 200 is input to the aerosol generating device 10, or when a signal for turning on the aerosol generating device 10 is input, the processor 120 may detect the temperature of the heater 130 through the temperature sensor 140.

The processor 120 may detect the initial temperature of the heater 130 through the temperature sensor 140 and thus may determine whether the input to the aerosol generating device 10 is associated with the continued smoking or the initial smoking. That is, when a user performs the first smoking with one cigarette by using the aerosol generating device 10 and then immediately performs the second smoking with another cigarette, the aerosol generating device 10 may determine that an input to the aerosol generating device 10 during the second smoking (e.g., a cigarette insertion signal, a power state switching signal, etc.) is the input regarding the continued smoking. When the input to the aerosol generating device 10 is the input regarding the continued smoking, the heater 130 of the aerosol generating device 10 is already heated, and thus, the heater 130 may be controlled according to a preheating profile that is different from a preheating profile used during the initial smoking,

Therefore, the aerosol generating device 10 according to an embodiment may distinguish the continued smoking and the initial smoking from each other based on the initial temperature of the heater 130 and thus may control, according to different temperature profiles, a heating operation regarding the cigarette inserted into the aerosol generating device 10.

In an embodiment, when the initial temperature of the heater 130 satisfies a certain condition, the processor 120 may obtain the final heating profile of the heater 130 from the memory (not shown). For example, when the initial temperature of the heater 130, which is detected through the temperature sensor 140, is equal to or higher than a preset temperature, the processor 120 may obtain the final heating profile of the heater 130 from the memory.

When the initial temperature of the heater 130 is equal to or higher than the preset temperature, the processor 120 may determine that the input to the aerosol generating device 10 in the smoking action is the input regarding the continued smoking. In this case, with regard to the smoking action corresponding to the continued smoking, the processor 120 may control the heater 130 according to different preheating profiles, based on the state of the cigarette in the previous smoking action.

For example, during the smoking action corresponding to the continued smoking, when the cigarette used during the previous smoking action is the cigarette in a normal state, the processor 120 may control the heater 130 according to a general preheating profile for the cigarette to be used in the continuous smoking action.

For example, during the smoking action corresponding to the continued smoking, when the cigarette used during the previous operation is the cigarette in an overhumidified state, the processor 120 may control the heater 130 according to an overhumidified preheating profile for the cigarette to be used in the continuous smoking action. That is, when the corresponding smoking action corresponds to the continued smoking and the cigarette used during the previous smoking action is excessively humid, the aerosol generating device 10 may assume that a cigarette to be used in the corresponding smoking action may be excessively humid and may apply an overhumidified preheating profile. In this case, the expressions “excessively humid” and “over-humidified” may be interchangeably used and may refer to a state in which the aerosol generating article 200 includes moisture of about 15 wt % or greater compared to the total weight of the article, but one or more embodiments are not limited thereto. The state may variously change according to the design of the manufacturer.

According to an embodiment, the processor 120 of the aerosol generating device 10 may control the power supply to the heater 130, based on the data obtained in operation 303. For example, the processor 120 may control the power supply to the heater 130 according to a normal preheating profile, based on the data associated with the initial temperature of the heater 130 (e.g., “the initial temperature<preset temperature” data). As another example, the processor 120 may control the power supply to the heater 130 according to the over-humidified preheating profile, based on the data associated with the initial temperature of the heater 130 (e.g., “the initial temperature≥preset temperature” data) and the data associated with the final heating profile of the heater 130 (e.g., the “over-humidified preheating profile” data). As another example, the processor 120 may control the power supply to the heater 130 according to the normal preheating profile, based on the data associated with the initial temperature of the heater 130 (e.g., “the initial temperature≥preset temperature” data) and the data associated with the final heating profile of the heater 130 (e.g., the “normal preheating profile” data).

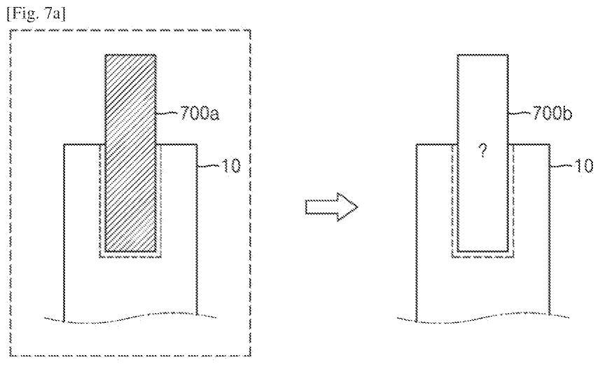

FIG. 4 is a detailed flowchart illustrating the aerosol generating device of FIG. 3 in which the power supply to a heater is controlled.

Referring to FIG. 4, in operation 401, a processor (e.g., the processor 120 of FIG. 1) of an acrosol generating device (e.g., the aerosol generating device 10 of FIG. 1) may obtain data associated with an initial temperature of a heater (e.g., the heater 130 of FIG. 1). For example, when a signal regarding the insertion of the aerosol generating article 200 is input to the aerosol generating device 10 (e.g., when insertion of the aerosol generating article 200 is detected), or when a signal for turning on the aerosol generating device 10 is input to the aerosol generating device 10, the processor 120 may detect the temperature of the heater 130 through a temperature sensor (e.g., the temperature sensor 140 of FIG. 1) and obtain the data associated with the initial temperature.

According to an embodiment, in operation 403, the processor 120 may determine whether the initial temperature of the heater 130 is equal to or higher than the preset temperature. In this case, for example, the term “preset temperature” may refer to the temperature of the heater 130 (e.g., an average temperature, a minimum temperature, etc.) which is measured when a certain period of time (e.g., two minutes) has passed after the heater 130 stopped heating.

According to an embodiment, when the initial temperature of the heater 130 detected through the temperature sensor 140 is equal to or higher than the preset temperature, the processor 120 may obtain the data associated with the final heating profile of the heater 130 from the memory, in operation 405. In this case, the term “final heating profile” may indicate a temperature profile applied to the heater 130 during previous smoking based on a point in time when smoking starts. For example, when the preset temperature is about 50° C. and the initial temperature of the heater 130 detected by the temperature sensor 140 is about 150° C., the processor 120 may obtain, from the memory, data indicating that the temperature profile applied to the heater 130 in the previous smoking is “a heating profile used to heat an over-humidified cigarette” or data indicating that the temperature profile applied to the heater 130 in the previous smoking is “a heating profile used to heat a normal cigarette.”

According to an embodiment, when the initial temperature of the heater 130 detected by the temperature sensor 140 is less than the preset temperature, the processor 120 may control the power supply to the heater 130 to correspond to a first temperature profile, in operation 411. In this case, the “first temperature profile” may refer to a temperature profile used to heat a normal cigarette.

According to an embodiment, in operation 407, the processor 120 may determine whether time corresponding to a temperature increase section of the final heating profile of the heater 130 is equal or longer than preset time. The final heating profile of the heater 130 may include a preheating profile, and the preheating profile may include “a temperature increase section” in which the temperature of the heater 130 increases to a target preheating temperature, “a temperature maintaining section” in which the temperature of the heater 130 is maintained, and “a temperature decrease section” in which the temperature of the heater 130 decreases to a preheating termination temperature. In this case, the processor 120 may determine whether the time corresponding to the “temperature increase section” of the preheating profile of the final heating profile of the heater 130 is equal to or longer than preset time, thus determining a state of the cigarette in the previous smoking action. For example, when the time corresponding to the “temperature increase section” of the final heating profile of the heater 130 is equal to or longer than the preset time, the processor 120 may determine that the cigarette in the previous smoking action, to which the final heating profile is applied, is in the “over-humidified state.” As another example, when the time corresponding to the “temperature increase section” is less than the preset time, the processor 120 may determine that the cigarette in the previous smoking action, to which the final heating profile is applied, is in the “normal state.”

According to an embodiment, when the time corresponding to the temperature increase section of the final heating profile of the heater 130 is equal to or longer than the preset time, the processor 120 may control the power supply to the heater 130 to correspond to the second temperature profile, in operation 409. In this case, the “second temperature profile” may refer to a temperature profile used to heat the cigarette in the over-humidified state.

According to an embodiment, when the time corresponding to the temperature increase section of the final heating profile of the heater 130 is less than the preset time, the processor 120 may control the power supply to the heater 130 to correspond to the first temperature profile, in operation 411.

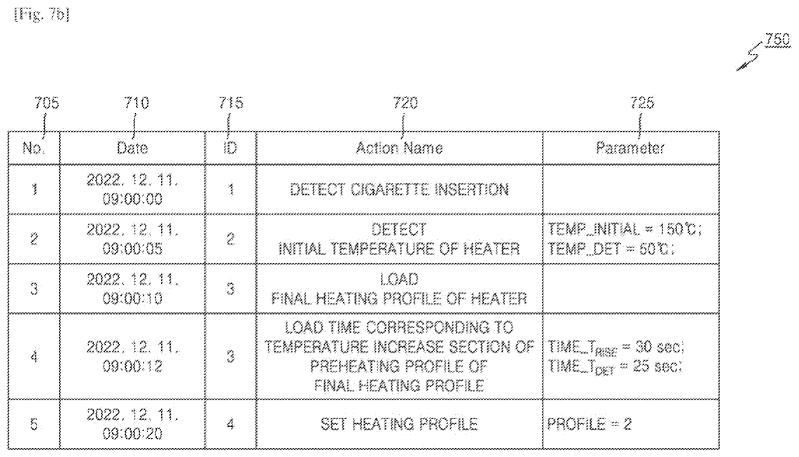

FIG. 5 illustrates a temperature profile including a preheating profile regarding an aerosol generating article in a normal state, according to an embodiment.

Referring to FIG. 5, as a signal input operation 500 of inputting a signal to an aerosol generating device (e.g., the aerosol generating device 10 of FIG. 1) is detected, a processor (e.g., the processor 120 of FIG. 1) may initiate a first preheating profile 505 regarding a heater (e.g., the heater 130 of FIG. 1). In this case, the signal input operation 500 may be an operation associated with an aerosol generating article in a normal state. For example, the signal input operation 500 may be an operation associated with the insertion of the aerosol generating article in the normal state or an operation associated with the switching of the power state of the aerosol generating device 10 after the aerosol generating article in the normal state is inserted.

In an embodiment, the processor 120 may perform a preheating operation on the aerosol generating article, based on the first preheating profile 505 during first preheating time 520. In this case, the first preheating profile 505 may include a first temperature increase section 510, a first temperature maintaining section 512, and a first temperature decrease section 514.

In an embodiment, the first temperature increase section 510 may refer to a section in which the temperature of the heater 130 increases to a target preheating temperature 530. After the signal input operation 500 is detected, the processor 120 may supply power to the heater 130 such that the temperature of the heater 130 increases to the target preheating temperature 530 in the first temperature increase section 510. In the present specification, the target preheating temperature 530 may refer to a temperature that is set to substantially increase the temperature of the heater 130 before the aerosol generating article is heated.

In an embodiment, the first temperature maintaining section 512 may refer to a section in which the temperature of the heater 130 is maintained at the target preheating temperature 530. After the temperature of the heater 130 reaches the target preheating temperature 530, the power may be supplied to the heater 130 to maintain the temperature of the heater 130 at the target preheating temperature 530, in the first temperature maintaining section 512.

In an embodiment, the first temperature decrease section 514 may refer to a section in which the temperature of the heater 130 decreases from the target preheating temperature 530 to a preheating termination temperature 535. After the temperature of the heater 130 is maintained at the target preheating temperature 530 for the preset maintaining time, the processor 120 may supply the power to the heater 130 to make the temperature of the heater 130 decrease to the preheating termination temperature 535, in the first temperature decrease section 514.

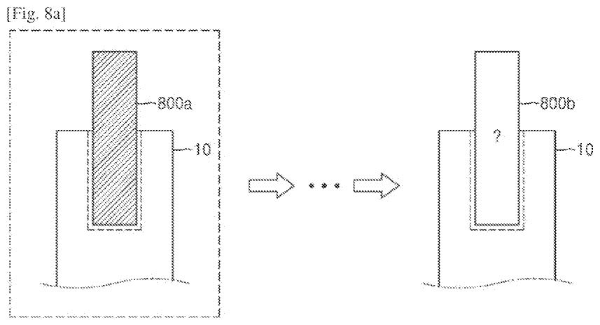

FIG. 6 illustrates a temperature profile including a preheating profile regarding an aerosol generating article in an over-humidified state, according to an embodiment.

Referring to FIG. 6, as a signal input operation 600 of inputting a signal to an aerosol generating device (e.g., the aerosol generating device 10 of FIG. 1) is detected, a processor (e.g., the processor 120 of FIG. 1) may initiate a second preheating profile 605 regarding a heater (e.g., the heater 130 of FIG. 1). In this case, the signal input operation 600 may be an operation associated with an aerosol generating article in an over-humidified state. For example, the signal input operation 600 may be an operation associated with the insertion of the aerosol generating article in the over-humidified state or an operation associated with the switching of the power state of the aerosol generating device 10 after the aerosol generating article in the over-humidified state is inserted.

In an embodiment, the processor 120 may preheat the aerosol generating article according to the second preheating profile 605. In this case, the second preheating profile 605 may include a second temperature increase section 610, a second temperature maintaining section, and a second temperature decrease section.

In an embodiment, the second temperature increase section 610 may refer to a section in which the temperature of the heater 130 increases to the target preheating temperature 530. After the signal input operation 600 is detected, the processor 120 may supply power to the heater 130 such that the temperature of the heater 130 increases to the target preheating temperature 530 in the second temperature increase section 610.

When the aerosol generating article in the over-humidified state is inserted, the time taken for the temperature of the heater 130 to reach the target preheating temperature 530 may be longer than the time taken when the aerosol generating article in the normal state is inserted. That is, the aerosol generating article in the over-humidified state contains a large amount of moisture compared to the normal aerosol generating article, and the temperature increase speed of the heater 130 may be relatively slow due to the moisture.

In an embodiment, when the time taken for the temperature of the heater 130 to reach the target preheating temperature 530 is longer than the preset time 630, the processor 120 may determine that the aerosol generating article inserted into the aerosol generating device 10 is in the “over-humidified state.” For example, when the temperature profile applied by the memory to the heater 130 during the previous smoking includes the second preheating profile 605, the time taken for the temperature of the heater 130 to reach the target preheating temperature 530 corresponds to the second temperature increase section 610 and the time is longer than the preset time 630. Thus, the processor 120 may determine the aerosol generating article inserted into the aerosol generating device 10 is in the “over-humidified state.”

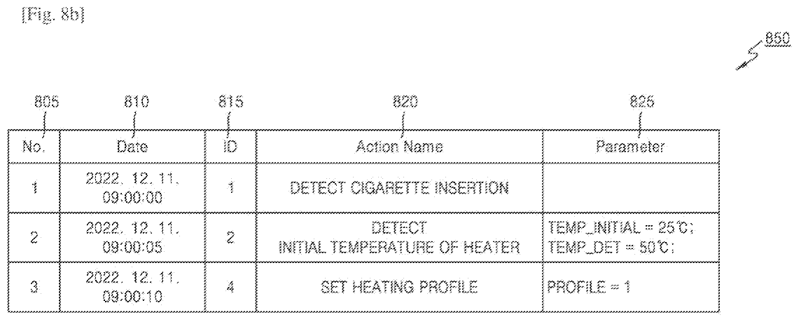

FIG. 7A illustrates that an aerosol generating article is continuously inserted after an aerosol generating article in an over-humidified state is inserted into an aerosol generating device, according to an embodiment.

Referring to FIG. 7A, the aerosol generating device 10 may include a housing including the accommodation space into which at least a portion of an aerosol generating article 700a is inserted. In this case, the aerosol generating article 700a may be a cigarette used during previous smoking based on a point in time when continued smoking is initiated, and the acrosol generating article 700a may be in the overhumidified state.

In an embodiment, as an aerosol generating article 700b is inserted within preset time after the previous smoking ends, the aerosol generating device 10 may detect that a new smoking action is continued smoking. In this case, the acrosol generating article 700b may be a cigarette that is to be used for the continued smoking. Alternatively, when a new smoking action is initiated within the preset time after the previous smoking action is terminated, the aerosol generating device 10 may not perform an operation of determining whether the aerosol generating article 700b is in the normal state or the over-humidified state.

FIG. 7B shows an example of data stored in a memory of the aerosol generating device of FIG. 7A. FIG. 7B shows a database format regarding an execution log of the processor (e.g., the processor 120 of FIG. 1) of the aerosol generating device (e.g., the aerosol generating device 10 of FIG. 1), but one or more embodiments are not limited thereto.

Referring to FIG. 7B, an execution log 750 of the processor 120 may include the number of times 705, a date and time 710, an ID 715 of a component, operation description 720 of a component, and a parameter 725. However, one or more embodiments are not limited thereto, and the execution log 750 may include various fields within a range that is obvious to one of ordinary skill in the art.

In an embodiment, log data 1 may be data indicating that the insertion of a cigarette (e.g., the aerosol generating article 200 of FIG. 1) into the aerosol generating device 10 is sensed. In this case, an ID 1 may be a sensor (e.g., a proximity sensor, etc.) for sensing the insertion of a cigarette into the aerosol generating device 10. For example, the processor 120 may detect the insertion of the cigarette through a sensor at ‘2022. 12. 11. 12. 11. 09:00:00’ and may store the log data 1 in the memory.

In an embodiment, log data 2 may be data indicating that an initial temperature of a heater (e.g., the heater 130 of FIG. 1) is detected. In this case, an ID 2 may be a temperature sensor (e.g., the temperature sensor 140 of FIG. 1) for measuring the temperature of the heater 130 in the aerosol generating device 10. Also, the processor 120 may detect the initial temperature of the heater 130 through the temperature sensor 140 at ‘2022. 12. 11. 09:00:05’ and may store the log data 2 in the memory. For example, when the detected initial temperature of the heater 130 is 150° C., the processor 120 may store, in the memory, ‘TEMP_INITIAL 150° C.’ as a parameter regarding the initial temperature of the heater 130. Then, the processor 120 may determine that the initial temperature of the heater 130 is equal to or higher than a preset temperature (e.g., 50° C.).

In an embodiment, log data 3 may be data used to load the final heating profile of the heater 130, and log data 4 may be data used to load time corresponding to the temperature increase section of the preheating profile of the final heating profile. In this case, an ID 3 may be a memory storing data in the aerosol generating device 10. Also, the processor 120 may load the final heating profile of the heater 130 from the memory at ‘2022. 12. 11. 09:00:10’ and may load, from the memory, time corresponding to the temperature increase section of the preheating profile of the final heating profile at ‘2022. 12. 11. 09:00:12.’ For example, when the time corresponding to the temperature increase section of the preheating profile of the final heating profile of the heater 130 is 30 seconds, the processor 120 may store, in the memory, ‘TIME_TRISE=30 sec’ as a parameter regarding the time corresponding to the temperature increase section of the heater 130. Then, the processor 120 may determine that the time corresponding to the temperature increase section of the heater 130 is equal to or longer than the preset time (e.g., 25 seconds).

In an embodiment, log data 5 may be data indicating that a heating profile to be applied to the heater 130 is set. In this case, an ID 4 may be the heater 130 for heating the cigarette 200. Also, the processor 120 may set the heating profile to be applied to the heater 130 at ‘2022. 12. 11. 09:00:20’ and may store the log data 5 in the memory. For example, because the initial temperature TEMP_INITIAL of the heater 130 is equal to or higher than a preset temperature TEMP_DET, and because the time TIME_TRISE Corresponding to the temperature increase section of the final heating profile of the heater 130 is equal to or longer than the preset time TIME_TDET, the processor 120 may set the heating profile, which is to be applied to the heater 130, as a second temperature profile PROFILE=2.

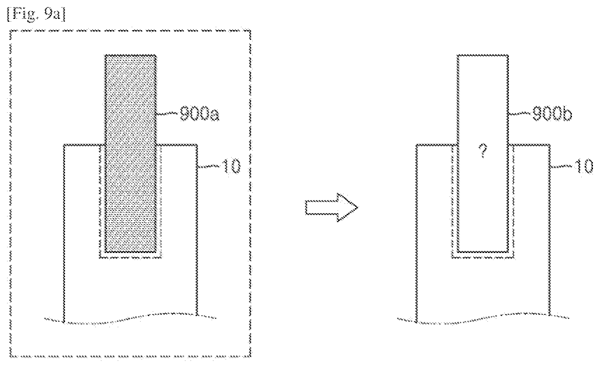

FIG. 8A illustrates a state in which an acrosol generating article is inserted after a certain period of time has passed after an over-humidified aerosol generating article is inserted into an aerosol generating device, according to an embodiment.

Referring to FIG. 8A, the aerosol generating device 10 may include a housing including an accommodation space into which at least a portion of an aerosol generating article 800a is inserted. In this case, the aerosol generating article 800a may be a cigarette used during previous smoking, based on a point in time when smoking is initiated, and may be in the over-humidified state.

In an embodiment, as an aerosol generating article 800b is inserted after preset time has passed after the previous smoking action is terminated, the aerosol generating device 10 may detect that a new smoking action is initial smoking. In this case, the aerosol generating article 800b may be a cigarette to be used for the new smoking action. When a new smoking action is initiated after the preset time has passed after the previous smoking action is terminated, the aerosol generating device 10 may determine whether the aerosol generating article 800b is in the normal state or the over-humidified state. Alternatively, the aerosol generating device 10 may assume that the aerosol generating article 800b is in the normal state, thereby controlling power supply to correspond to a temperature profile for heating a cigarette in the normal state.

FIG. 8B illustrates an example of data stored in a memory of the aerosol generating device of FIG. 8A. FIG. 8B shows a database format regarding an execution log of the processor (e.g., the processor 120 of FIG. 1) of the aerosol generating device (e.g., the aerosol generating device 10 of FIG. 1), but one or more embodiments are not limited thereto.

Referring to FIG. 8B, an execution log 850 of the processor 120 may include the number of times 805, a date and time 810, an ID 815 of a component, operation description 820 of a component, and a parameter 825. However, one or more embodiments are not limited thereto, and the execution log 850 may include various fields within a range that is obvious to one of ordinary skill in the art,

In an embodiment, log data 1 may be data indicating that the insertion of a cigarette (e.g., the aerosol generating article 200 of FIG. 1) into the aerosol generating device 10 is sensed. In this case, the ID 1 may be a sensor (e.g., a proximity sensor, etc.) for detecting the insertion of the cigarette into the aerosol generating device 10. For example, the processor 120 may detect the insertion of the cigarette through a sensor at ‘2022. 12. 11. 09:00:00’ and may store the log data 1 in the memory.

In an embodiment, log data 2 may be data indicating that an initial temperature of a heater (e.g., the heater 130 of FIG. 1) is detected. In this case, an ID 2 may be a temperature sensor (e.g., the temperature sensor 140 of FIG. 1) for measuring the temperature of the heater 130 in the aerosol generating device 10. Also, the processor 120 may detect the initial temperature of the heater 130 through the temperature sensor 140 at ‘2022. 12. 11. 09:00:05’ and may store the log data 2 in the memory. For example, when the detected initial temperature of the heater 130 is 25° C., the processor 120 may store, in the memory, ‘TEMP_INITIAL=25° C.’ as a parameter regarding the initial temperature of the heater 130. Then, the processor 120 may determine that the initial temperature of the heater 130 is lower than a preset temperature (e.g., 50° C.).

In an embodiment, log data 3 may be data indicating that a heating profile to be applied to the heater 130 is set. In this case, an ID 4 may be the heater 130 for heating the cigarette 200. Also, the processor 120 may set the heating profile to be applied to the heater 130 at ‘2022. 12. 11. 09:00:10’ and may store the log data 3 in the memory. For example, because the initial temperature TEMP_INITIAL of the heater 130 is lower than the preset temperature TEMP_DET, the processor 120 may set the heating profile, which is to be applied to the heater 130, as a first temperature profile PROFILE=1.

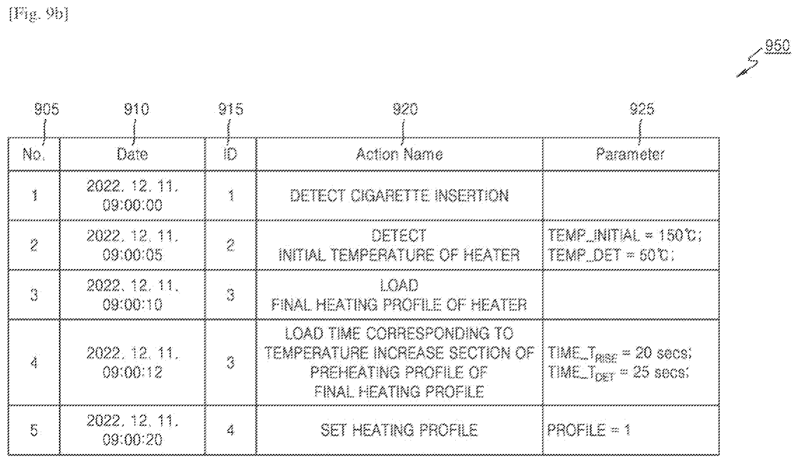

FIG. 9A illustrates that an aerosol generating article is continuously inserted after an aerosol generating article in a normal state is inserted into an aerosol generating device, according to an embodiment.

Referring to FIG. 9A, the aerosol generating device 10 may include a housing including the accommodation space into which at least a portion of an aerosol generating article 900a is inserted. In this case, the acrosol generating article 900a may be a cigarette used during previous smoking, based on a point in time when smoking is initiated, and may be in the normal state.

In an embodiment, as an aerosol generating article 900b is inserted within preset time after a previous smoking action ends, the aerosol generating device 10 may detect that a new smoking action is continued smoking. In this case, the aerosol generating article 900b may be a cigarette that is to be used as for the continued smoking. However, when a new smoking action is initiated within the preset time after the previous smoking action is terminated, the aerosol generating device 10 may not perform an operation of determining whether the aerosol generating article 900b is in the normal state or the over-humidified state.

FIG. 9B illustrates an example of data stored in a memory of the aerosol generating device of FIG, 9A. FIG. 9B shows a database format regarding an execution log of the processor (e.g., the processor 120 of FIG. 1) of the aerosol generating device (e.g., the aerosol generating device 10 of FIG. 1), but one or more embodiments are not limited thereto.

Referring to FIG. 9B, an execution log 950 of the processor 120 may include the number of times 905, a date and time 910, an ID 915 of a component, operation description 920 of a component, and a parameter 925. However, one or more embodiments are not limited thereto, and the execution log 950 may include various fields within a range that is obvious to one of ordinary skill in the art.

In an embodiment, log data 1 may be data indicating that the insertion of a cigarette (e.g., the aerosol generating article 200 of FIG. 1) into the aerosol generating device 10 is sensed. In this case, the ID 1 may be a sensor (e.g., a proximity sensor, etc.) for detecting the insertion of the cigarette into the aerosol generating device 10. For example, the processor 120 may detect the insertion of the cigarette through a sensor at ‘2022. 12. 11. 09:00:00’ and may store the log data 1 in the memory.

In an embodiment, log data 2 may be data indicating that an initial temperature of a heater (e.g., the heater 130 of FIG. 1) is detected. In this case, an ID 2 may be a temperature sensor (e.g., the temperature sensor 140 of FIG. 1) for measuring the temperature of the heater 130 in the aerosol generating device 10. Also, the processor 120 may detect the initial temperature of the heater 130 through the temperature sensor 140 at ‘2022. 12. 11. 09:00:05’ and may store the log data 2 in the memory. For example, when the detected initial temperature of the heater 130 is 150° C., the processor 120 may store, in the memory, ‘TEMP_INITIAL=150° C.’ as a parameter regarding the initial temperature of the heater 130. Then, the processor 120 may determine that the initial temperature of the heater 130 is equal to or higher than a preset temperature (c.g., 50° C.).

In an embodiment, log data 3 may be data used to load the final heating profile of the heater 130, and log data 4 may be data used to load time corresponding to the temperature increase section of the preheating profile of the final heating profile. In this case, the ID 3 may be a memory storing data in the aerosol generating device 10. Also, the processor 120 may load the final heating profile of the heater 130 from the memory at ‘2022. 12. 11. 09:00:10’ and may load, from the memory, time corresponding to the temperature increase section of the preheating profile of the final heating profile at ‘2022. 12. 11. 09:00:12. ’ For example, when the time corresponding to the temperature increase section of the preheating profile of the final heating profile of the heater 130 is 30 seconds, the processor 120 may store, in the memory, ‘TIME_TRISE=20 sec’ as a parameter regarding the time corresponding to the temperature increase section of the heater 130. Then, the processor 120 may determine that the time corresponding to the temperature increase section of the heater 130 is less than the preset time (e.g., 25 seconds).

In an embodiment, log data 5 may be data indicating that a heating profile to be applied to the heater 130 is set. In this case, an ID 4 may be the heater 130 for heating the cigarette 200. Also, the processor 120 may set the heating profile, which is to be applied to the heater 130, at ‘2022. 12. 11. 09:00:20’ and may store the log data 5 in the memory. For example, because the initial temperature TEMP_INITIAL of the heater 130 is equal to or higher than the preset temperature TEMP_DET, and because time TIME_TRISE corresponding to the temperature increase section of the final heating profile of the heater 130 is less than the preset time TIME_TDET, the processor 120 may set the heating profile, which is to be applied to the heater 130, as the first temperature profile PROFILE=1.

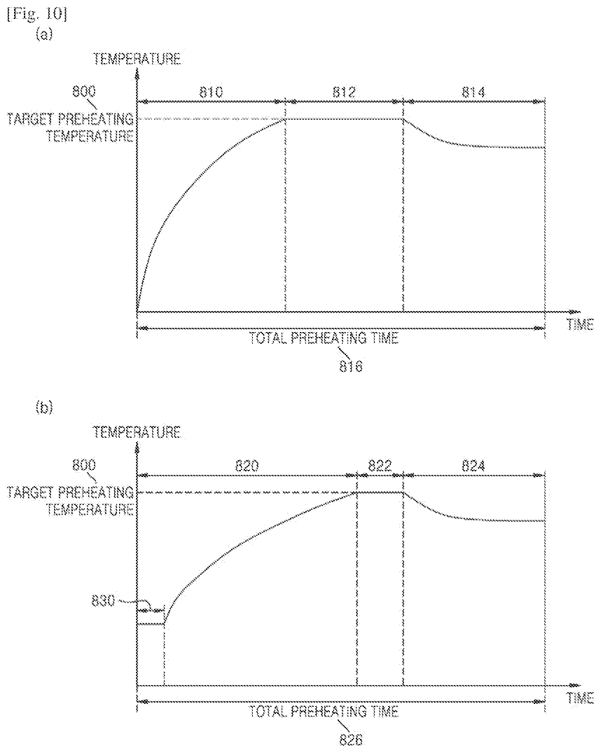

FIG. 10 illustrates an example of a first temperature profile and a second temperature profile, according to an embodiment. However, in the detailed description of FIG. 10, descriptions that correspond to, are the same as, or similar to those provided above may be omitted.

Referring to FIG. 10, the graph (a) may represent a first temperature profile regarding a heater (e.g., the heater 130 of FIG. 1), and the graph (b) may represent a second temperature profile regarding the heater 130. In this case, the “first temperature profile” may be the temperature profile for heating a cigarette in the normal state, and the “second temperature profile” may be the temperature profile for heating a cigarette in the over-humidified state. In more detail, the “second temperature profile” may refer to a temperature profile for heating a cigarette that is assumed to be excessively humid in a continuous smoking action.

The graph (a) shows a first preheating profile including a first temperature increase section 810, a first temperature maintaining section 812, and a first temperature decrease section 814 in the first temperature profile. The graph (b) shows a second preheating profile including a second temperature increase section 820, a second temperature maintaining section 822, and a second temperature decrease section 824 in the second temperature profile.

In an embodiment, the first preheating profile may be different from the second preheating profile. For example, the total time (i.e., the total preheating time 826) corresponding to the second preheating profile may be longer than the total time (i.e., the total preheating time 816) corresponding to the first preheating profile.

In an embodiment, the second preheating profile may include delay time 830, unlike the first preheating profile. For example, the second preheating profile may be a temperature profile applied during the continuous smoking action, and during the continuous smoking action, the heater is already heated in the previous smoking action, the processor (e.g., the processor 120 of FIG. 1) may maintain the initial temperature of the heater 130 for first time (that is, the delay time 830) and then control the power supply to make the temperature of the heater 130 increase to a target preheating temperature 800.

In an embodiment, the processor 120 may obtain the delay time 830 included in the second preheating profile, through anti-windup controlling. For example, the processor 120 may obtain the delay time 830 included in the second preheating profile through the anti-windup controlling, such as clamping or back-calculation.

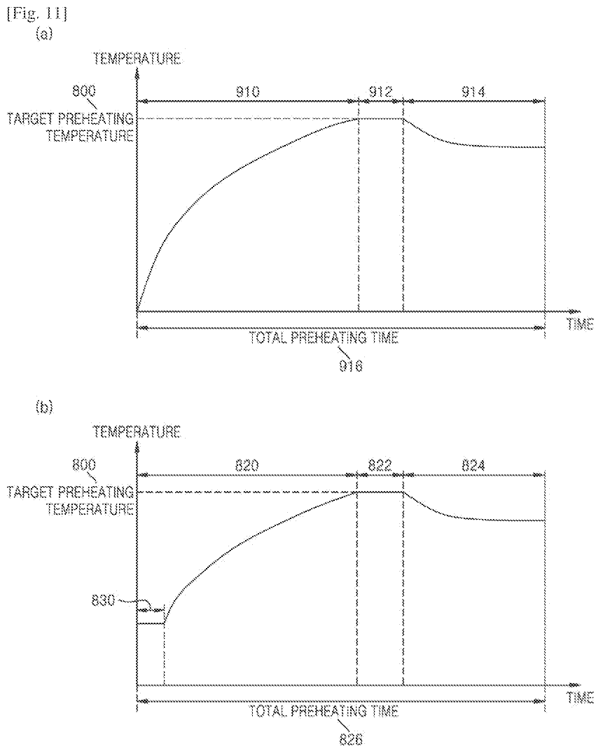

FIG. 11 illustrates an example of a final heating profile and a second temperature profile, according to an embodiment. However, in the detailed description of FIG. 11, descriptions that correspond to, are the same as, or similar to those provided above may be omitted.

Referring to FIG. 11, when a first smoking action is performed on one overhumidified cigarette by using the aerosol generating device (e.g., the aerosol generating device 10 of FIG. 1), and when a second smoking action is performed on another cigarette immediately after the first smoking action, the graph (a) may represent a temperature profile regarding the heater (e.g., the heater 130 of FIG. 1) during the first smoking action, and the graph (b) may represent a temperature profile regarding the heater 130 during the second smoking action. In this case, the expression “temperature profile during the first smoking action” may refer to the final heating profile of the heater 130, and the “temperature profile during the second smoking action” may refer to the temperature profile (that is, the second temperature profile) for heating a cigarette that is assumed to be over-humidified and is used during the continuous smoking action.

The graph (a) shows a preheating profile including a temperature increase section 910, a temperature maintaining section 912, and a temperature decrease section 914, in the final heating profile of the heater 130. The graph (b) shows a second preheating profile including the second temperature increase section 820, the second temperature maintaining section 822, and the second temperature decrease section 824 in the second temperature profile.

In an embodiment, the final heating profile of the heater 130 may be different from the second temperature profile. For example, time 824 corresponding to the temperature decrease section of the preheating profile of the second temperature profile may be less than time 914 corresponding to the temperature decrease section of the preheating profile of the final heating profile of the heater 130.

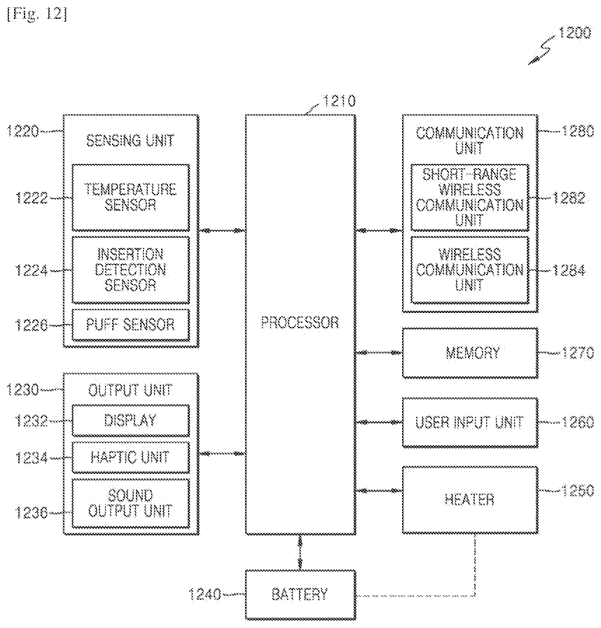

FIG. 12 is a block diagram of an aerosol generating device 1200 according to another embodiment.

The aerosol generating device 1200 may include a controller 1210, a sensing unit 1220, an output unit 1230, a battery 1240, a heater 1250, a user input unit 1260, a memory 1270, and a communication unit 1280. However, the internal structure of the aerosol generating device 1200 is not limited to those illustrated in FIG. 12. That is, according to the design of the aerosol generating device 1200, it will be understood by one of ordinary skill in the art that some of the components shown in FIG. 12 may be omitted or new components may be added.

The sensing unit 1220 may sense a state of the aerosol generating device 1200 and a state around the aerosol generating device 1200, and transmit sensed information to the controller 1210. Based on the sensed information, the controller 1210 may control the aerosol generating device 1200 to perform various functions, such as controlling an operation of the heater 1250, limiting smoking, determining whether an aerosol generating article (e.g., a cigarette, a cartridge, or the like) is inserted, displaying a notification, or the like.

The sensing unit 1220 may include at least one of a temperature sensor 1222, an insertion detection sensor, and a puff sensor 1226, but is not limited thereto.

The temperature sensor 1222 may sense a temperature at which the heater 1250 (or an aerosol generating material) is heated. The aerosol generating device 1200 may include a separate temperature sensor for sensing the temperature of the heater 1250, or the heater 1250 may serve as a temperature sensor. Alternatively, the temperature sensor 1222 may also be arranged around the battery 1240 to monitor the temperature of the battery 1240.

The insertion detection sensor 1224 may sense insertion and/or removal of an aerosol generating article. For example, the insertion detection sensor 1224 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 1226 may sense a user's puff on the basis of various physical changes in an airflow passage or an airflow channel. For example, the puff sensor 1226 may sense a user's puff on the basis of any one of a temperature change, a flow change, a voltage change, and a pressure change.

The sensing unit 1220 may include, in addition to the temperature sensor 1222, the insertion detection sensor 1224, and the puff sensor 1226 described above, at least one of a temperature/humidity sensor, a barometric pressure sensor, a magnetic sensor, an acceleration sensor, a gyroscope sensor, a location sensor (c.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 1230 may output information on a state of the aerosol generating device 1200 and provide the information to a user. The output unit 1230 may include at least one of a display unit 1232, a haptic unit 1234, and a sound output unit 1236, but is not limited thereto. When the display unit 1232 and a touch pad form a layered structure to form a touch screen, the display unit 1232 may also be used as an input device in addition to an output device.

The display unit 1232 may visually provide information about the aerosol generating device 1200 to the user. For example, information about the aerosol generating device 1200 may mean various pieces of information, such as a charging/discharging state of the battery 1240 of the aerosol generating device 1200, a preheating state of the heater 1250, an insertion/removal state of an aerosol generating article, or a state in which the use of the aerosol generating device 1200 is restricted (e.g., sensing of an abnormal object), or the like, and the display unit 1232 may output the information to the outside. The display unit 1232 may be, for example, a liquid crystal display panel (LCD), an organic light-emitting diode (OLED) display panel, or the like. In addition, the display unit 1232 may be in the form of a light-emitting diode (LED) light-emitting device.

The haptic unit 1234 may tactilely provide information about the aerosol generating device 1200 to the user by converting an electrical signal into a mechanical stimulus or an electrical stimulus. For example, the haptic unit 1234 may include a motor, a piezoelectric element, or an electrical stimulation device.

The sound output unit 1236 may audibly provide information about the aerosol generating device 1200 to the user. For example, the sound output unit 1236 may convert an electrical signal into a sound signal and output the same to the outside.

The battery 1240 may supply power used to operate the aerosol generating device 1200. The battery 1240 may supply power such that the heater 1250 may be heated. In addition, the battery 1240 may supply power required for operations of other components (e.g., the sensing unit 1220, the output unit 1230, the user input unit 1260, the memory 1270, and the communication unit 1280) in the aerosol generating device 1200. The battery 1240 may be a rechargeable battery or a disposable battery. For example, the battery 1240 may be a lithium polymer (LiPoly) battery, but is not limited thereto.

The heater 1250 may receive power from the battery 1240 to heat an aerosol generating material. Although not illustrated in FIG. 12, the aerosol generating device 1200 may further include a power conversion circuit (e.g., a direct current (DC)/DC converter) that converts power of the battery 1240 and supplies the same to the heater 1250. In addition, when the aerosol generating device 1200 generates aerosols in an induction heating method, the aerosol generating device 1200 may further include a DC/alternating current (AC) that converts DC power of the battery 1240 into AC power.

The controller 1210, the sensing unit 1220, the output unit 1230, the user input unit 1260, the memory 1270, and the communication unit 1280 may each receive power from the battery 1240 to perform a function. Although not illustrated in FIG. 12, the aerosol generating device 1200 may further include a power conversion circuit that converts power of the battery 1240 to supply the power to respective components, for example, a low dropout (LDO) circuit, or a voltage regulator circuit,

In an embodiment, the heater 1250 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 1250 may be implemented by a metal wire, a metal plate on which an electrically conductive track is arranged, a ceramic heating element, or the like, but is not limited thereto.

In another embodiment, the heater 1250 may be a heater of an induction heating type. For example, the heater 1250 may include a suspector that heats an aerosol generating material by generating heat through a magnetic field applied by a coil.

The user input unit 1260 may receive information input from the user or may output information to the user. For example, the user input unit 1260 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 12, the aerosol generating device 1200 may further include a connection interface, such as a universal serial bus (USB) interface, and may connect to other external devices through the connection interface, such as the USB interface, to transmit and receive information, or to charge the battery 1240.

The memory 1270 is a hardware component that stores various types of data processed in the aerosol generating device 1200, and may store data processed and data to be processed by the controller 1210. The memory 1270 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 1270 may store an operation time of the aerosol generating device 1200, the maximum number of puffs, the current number of puffs, at least one temperature profile, data on a user's smoking pattern, etc.

The communication unit 1280 may include at least one component for communication with another electronic device. For example, the communication unit 1280 may include a short-range wireless communication unit 1282 and a wireless communication unit 1284.

The short-range wireless communication unit 1282 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+communication unit, or the like, but is not limited thereto.

The wireless communication unit 1284 may include a cellular network communication unit, an Internet communication unit, a computer network (e.g., local area network (LAN) or wide area network (WAN)) communication unit, or the like, but is not limited thereto. The wireless communication unit 1284 may also identify and authenticate the aerosol generating device 1200 within a communication network by using subscriber information (e.g., International Mobile Subscriber Identifier (IMSI)).

The controller 1210 may control general operations of the aerosol generating device 1200. In an embodiment, the controller 1210 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 1210 may control the temperature of the heater 1250 by controlling supply of power of the battery 1240 to the heater 1250. For example, the controller 1210 may control power supply by controlling switching of a switching element between the battery 1240 and the heater 1250. In another example, a direct heating circuit may also control power supply to the heater 1250 according to a control command of the controller 1210.

The controller 1210 may analyze a result sensed by the sensing unit 1220 and control subsequent processes to be performed. For example, the controller 1210 may control power supplied to the heater 1250 to start or end an operation of the heater 1250 on the basis of a result sensed by the sensing unit 1220. As another example, the controller 1210 may control, based on a result sensed by the sensing unit 1220, an amount of power supplied to the heater 1250 and the time the power is supplied, such that the heater 1250 may be heated to a certain temperature or maintained at an appropriate temperature.

The controller 1210 may control the output unit 1230 on the basis of a result sensed by the sensing unit 1220. For example, when the number of puffs counted through the puff sensor 1226 reaches a preset number, the controller 1210 may notify the user that the aerosol generating device 1200 will soon be terminated through at least one of the display unit 1232, the haptic unit 1234, and the sound output unit 1236.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a housing comprising an accommodation space for accommodating at least a portion of an aerosol generating article;
a heater configured to heat the aerosol generating article inserted into the accommodation space;
a temperature sensor configured to measure a temperature of the heater;
a battery configured to supply power to the heater; and
a processor electrically connected to the heater and the battery, wherein the processor is configured to:
obtain at least one of data associated with an initial temperature of the heater, which is measured through the temperature sensor, and data associated with a final heating profile of the heater; and
control power supply from the battery to the heater, based on the obtained data.

2. The aerosol generating device of claim 1, further comprising a memory storing data associated with the final heating profile of the heater, wherein the processor is further configured to:
control the power supply to the heater to correspond to a first temperature profile when the initial temperature of the heater is lower than a preset temperature, and
obtain, from the memory, the data associated with the final heating profile of the heater when the initial temperature of the heater is equal to or higher than the preset temperature.

3. The aerosol generating device of claim 2, wherein the processor is further configured to, when the initial temperature of the heater is equal to or higher than the preset temperature, obtain, from the memory, data regarding time corresponding to a temperature increase section of a preheating profile of the final heating profile.

4. The aerosol generating device of claim 3, wherein the processor is further configured to, when the time corresponding to the temperature increase section is equal to or longer than preset time, control the power supply to the heater to correspond to a second temperature profile distinguished from the first temperature profile.

5. The aerosol generating device of claim 4, wherein total time corresponding to a preheating profile of the second temperature profile is longer than total time corresponding to a preheating profile of the first temperature profile.

6. The aerosol generating device of claim 4, wherein time corresponding to a temperature decrease section of a preheating profile of the second temperature profile is less than the time corresponding to the temperature decrease section of the preheating profile of the final heating profile.

7. The aerosol generating device of claim 4, wherein the second temperature profile maintains the initial temperature of the heater for first time and then increases the initial temperature.

8. The aerosol generating device of claim 7, wherein the processor is further configured to obtain the first time through anti-windup controlling.

9. An operating method of an aerosol generating device, the operating method comprising:
obtaining at least one of data associated with an initial temperature of the heater configured to heat an aerosol generating article inserted into an accommodation space and data associated with a final heating profile of the heater, the initial temperature being measured; and
controlling power supply from a battery to the heater, based on the obtained data.

10. The operating method of claim 9, the controlling comprises:
controlling the power supply to the heater to correspond to a first temperature profile when the initial temperature of the heater is lower than a preset temperature; and
obtaining, from the memory, data associated with the final heating profile of the heater when the initial temperature of the heater is equal to or higher than the preset temperature,

11. The operating method of claim 10, the data associated with the final heating profile comprises time corresponding to a temperature increase section of a preheating profile of the final heating profile.

12. The operating method of claim 11, the controlling comprises, when the time corresponding to the temperature increase section is equal to or longer than preset time, controlling the power supply to the heater to correspond to a second temperature profile distinguished from the first temperature profile.

13. The operating method of claim 12, wherein total time corresponding to a preheating profile of the second temperature profile is longer than total time corresponding to a preheating profile of the first temperature profile.

14. The operating method of claim 12, wherein time corresponding to a temperature decrease section of a preheating profile of the second temperature profile is less than the time corresponding to the temperature decrease section of the preheating profile of the final heating profile.

15. The operating method of claim 12, the second temperature profile maintains the initial temperature of the heater for first time and then increases the initial temperature.
